(19) United States
(12) Patent Application Publication
(10) Pub. No.: US 2013/0179068 A1
(43) Pub. Date: Jul. 11, 2013

(54) NAVIGATION SYSTEM FOR VEHICLE AND NAVIGATION METHOD THEREOF

(71) Applicants: Young-kyu JIN, Seoul (KR); Young-ho Rhee, Yongin-si (KR); Il-ku Chang, Seongnam-si (KR)

(72) Inventors: Young-kyu JIN, Seoul (KR); Young-ho Rhee, Yongin-si (KR); Il-ku Chang, Seongnam-si (KR)

(73) Assignee: Samsung Electronics Co., Ltd., Gyeonggi-do (KR)

(21) Appl. No.: 13/569,876

(22) Filed: Aug. 8, 2012

(30) Foreign Application Priority Data
Jan. 5, 2012 (KR) 10-2012-0001724

(51) Int. Cl. G01C 21/36

(52) U.S. Cl. 701/425

(57) ABSTRACT

A navigation system and method includes when a navigation function is selected, inputting destination and receiver information, displaying a navigation screen to guide a user to the destination using the input information, and when a predetermined message sending condition is satisfied while operating a vehicle to the destination, sending a message to be forwarded to the receiver information. Accordingly, a user sends a desired message without manipulating a user terminal apparatus separately while operating a vehicle.

### PRIORITY

This application claims priority under 35 U.S.C. §119 to Korean Patent Application No. 10-2012-0001724, which was filed on Jan. 5, 2012 in the Korean Intellectual Property Office, the entire disclosure of which is incorporated herein by reference.

### BACKGROUND OF THE INVENTION

1. Field of the Invention

The present invention relates generally to a navigation system for a vehicle and a navigation method thereof, and more particularly, to a navigation system for a vehicle, which can be interlocked with a user terminal apparatus, and a navigation method thereof.

2. Description of the Related Art

With the development of electronic technologies, various types of electronic apparatuses are mounted and used in vehicles, such as a navigation apparatus. The navigation apparatus is an apparatus that recognizes a current location of a vehicle and guides a user to a destination using map information.

A user drives the vehicle to a destination according to the guidance of the navigation apparatus. A modern navigation apparatus provides not only basic navigation functionality but also various additional functions such as receiving Digital Multimedia Broadcasting (DMB) and reproducing a moving image and an audio file. The navigation apparatus may be purchased separately from the vehicle and may be installed in the vehicle or may be mounted on the vehicle.

A user may make a call or exchange a text message using a mobile phone while operating a vehicle. However, if a user is not focusing on operating the vehicle, the user may have an accident. In practice, users frequently encounter this situation, and in particular, frequently use a mobile phone in order to inform another person at the destination about an expected time of arrival several minutes before arriving at the destination.

Accordingly, there is a demand for a method for preventing dangerous use of a mobile phone while operating a vehicle and improving user's convenience.

### SUMMARY OF THE INVENTION

Accordingly, the present invention has been made to solve the above-mentioned problems and disadvantages occurring in the prior art, and the present invention provides a navigation system for a vehicle, which is interlocked with a user terminal apparatus and improves user's safety and convenience, and a navigation method thereof.

According to an aspect of the present invention, there is provided a navigation method of a navigation system for a vehicle, the navigation method including when a navigation function is selected, inputting destination and receiver information, displaying a navigation screen to guide a user to the destination using the input information, and, when a predetermined message sending condition is satisfied while operating the vehicle to the destination, sending a message to be forwarded to the receiver information.

According to another aspect of the present invention, there is provided a navigation system for a vehicle, the navigation system including a storage unit which stores map information, a location detection unit which detects a location of the navigation system, a controller which searches for a path to a destination using the map information and the detected location, and forms a navigation screen, a display unit which displays the navigation screen, and a communication interface unit through which a message is sent, and, when a message sending condition is satisfied while a user runs the vehicle to the destination, the controller controls the communication interface unit to send a message to be forwarded to pre-input receiver information.

### BRIEF DESCRIPTION OF THE DRAWINGS

The above and/or other features, aspects and advantages of the present invention will be more apparent from the following detailed description taken in conjunction with the accompanying drawings, in which:

FIG. 1 is a diagram illustrating an operation of a navigation system for a vehicle according to an embodiment of the present invention;

FIG. 2 is a block diagram illustrating a navigation system for a vehicle according to an embodiment of the present invention;

FIG. 3 is a diagram illustrating an example of a process of setting destination and a message sending function in the navigation system, according to an embodiment of the present invention;

FIG. 4 is a diagram illustrating an example of a User Interface (UI) screen to set a message sending condition, according to an embodiment of the present invention;

FIG. 5 is a block diagram illustrating a user terminal apparatus according to an embodiment of the present invention;

FIG. 6 is a flowchart illustrating a navigation method according to an embodiment of the present invention; and

FIG. 7 is a diagram illustrating a timing chart for an interlocking process between a navigation system and a user terminal apparatus according to an embodiment of the present invention.

### DETAILED DESCRIPTION OF EMBODIMENTS OF THE PRESENT INVENTION

Hereinafter, embodiments of the present invention will be described in greater detail with reference to the accompanying drawings, in which aspects of the present invention are illustrated.

In the following description, same reference numerals are used for the same elements throughout the drawings. Well-known functions or elements may be omitted to avoid obscuring the description with unnecessary detail.

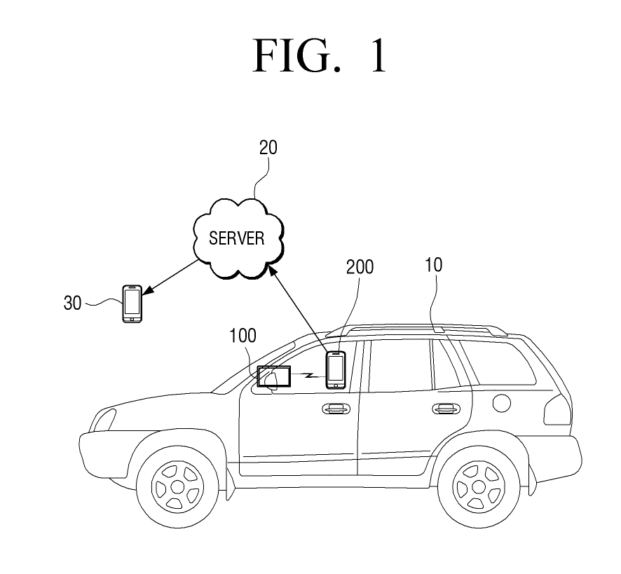

FIG. 1 is a diagram illustrating an operation of a navigation system for a vehicle according to an embodiment of the present invention. Referring to FIG. 1, a navigation system 100 is mounted in a vehicle 10. The navigation system 100 is manufactured as a separate apparatus and connected to an inside of the vehicle 10 or may be built-in the vehicle 10.

The navigation system 100 provides navigation to a destination selected by a user. If it is determined that a pre-selected message sending condition is satisfied while the user runs the vehicle 10, the navigation system 100 processes a message to be forwarded to a receiver.

Specifically, the navigation system 100 is connected to a user terminal apparatus 200 carried by a user vehicle in a wired or wireless manner. Accordingly, when the message sending condition is satisfied, the navigation system 100 sends a message to the user terminal apparatus 200 of the vehicle user. The user terminal apparatus 200 sends the message to a sever 20 so that the message can be sent to a receiver terminal apparatus 30. The message sending condition is set to various values such as a remaining distance to a destination, an estimated time required to arrive, and an estimated time of arrival according to embodiments of the present invention.

The receiver information is a phone number and the message is a Short Message Service (SMS) message or a Multimedia Message Service (MMS) message. Additionally, the receiver information is an e-mail address and the message is an e-mail message. The receiver information is not limited to a single receiver and the message is sent to a plurality of receivers simultaneously.

For example, when destination is set to a hotel, the navigation system 100 sends an SMS message requesting the hotel lobby to prepare to perform a check-in process ten minutes before arriving at the hotel. Accordingly, the hotel can get ready to perform a check-in process in advance and thus improving user convenience.

Alternatively, even when a destination is not selected, the navigation system 100 sends a message to inform a receiver of a current location on a predetermined time basis. If a condition is set to send a message every hour, the navigation system 100 determines arrival of a pre-set time based on a time provided from a timer included in the navigation system 100 or a Global Positioning System (GPS) satellite.

When the pre-set time arrives, the navigation system 100 automatically generates a message including information on a current location of the navigation system 100 and sends the message to the user terminal apparatus 200. The user terminal apparatus 200 sends pre-selected receiver information and the message to the server 20. The receiver information is already stored in the navigation system 100 or the user terminal apparatus 200.

In FIG. 1, the navigation system 100 is connected to the user terminal apparatus 200 and sends the message to the receiver terminal apparatus 30 through the user terminal apparatus 200 and the server 20. However, when the navigation system 100 includes a communication module, the navigation system 100 sends the message to the server 20 directly.

The navigation system 100 or the user terminal apparatus 200 outputs a User Interface (UI) or a voice message requesting user confirmation prior to sending the message, and sends the message when user confirmation is received in response to the UI or the voice message.

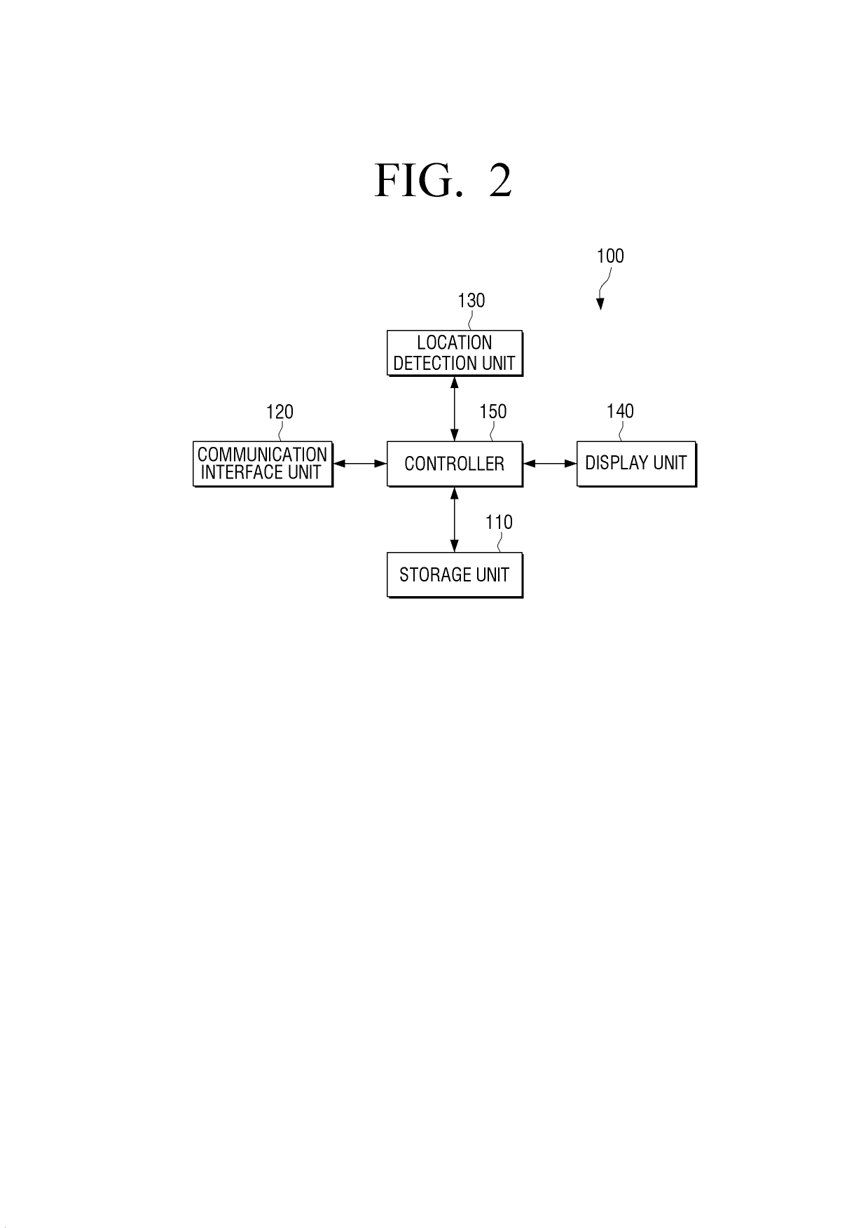

FIG. 2 is a block diagram illustrating a navigation system 100 according to an embodiment. Referring to FIG. 2, a navigation system 100 includes a storage unit 110, a communication interface unit 120, a location detection unit 130, a display unit 140, and a controller 150.

The storage unit 110 stores map information, navigation firmware, and other applications and data. The storage unit 110 stores destination information, receiver information, a message sending condition, and a message text, which are input by a user in the process of executing a navigation function.

The location detection unit 130 detects a location of the navigation system 100. Specifically, the location detection unit 130 includes a GPS module and detects a location using a GPS signal. The GPS module receives signals transmitted from a plurality of GPS satellites and calculates a distance between the satellite and the navigation system 100 using a time difference between a transmitting time and a receiving time. The GPS module calculates a current location of the navigation system 100 using a calculation method such as triangulation in consideration of the distance between the navigation system 100 and each of the plurality of satellites and the location of the satellite. The navigation system 100, according to an embodiment of the present invention, is mounted and used in a vehicle, and therefore the location of the navigation system 100 corresponds to the location of the vehicle.

The controller 150 searches for a path to a destination using the location detected by the location detection unit 130 and the map information stored in the storage unit 110. The controller 150 configures a navigation screen indicating the searched path and displays the navigation screen through the display unit 140. The navigation screen is displayed as a plane image or a 3-dimensional image according to a specification of the navigation system 100. The controller 150 may include a rendering module (not shown) to configure the navigation screen.

The communication interface unit 120 is connected to the user terminal apparatus 200 in a wired or wireless manner and communicates with the user terminal apparatus 200. Specifically, the communication interface unit 120 communicates with the user terminal apparatus 200 using a USB standard, Bluetooth®, Wi-Fi, and other well-known wired or wireless protocols.

If a message sending condition is satisfied while a user drives a vehicle to a destination, the controller 150 controls the communication interface unit 120 to send a message to be forwarded to receiver information. Although the communication interface unit 120 directly sends the message to a receiver using the receiver information according to an embodiment of the present invention, the communication interface unit 120 sends the message through the user terminal apparatus 200 as in FIG. 2.

If a navigation function is selected, the controller 150 controls the display unit 140 to display a UI screen to receive input of a variety of information necessary for executing the navigation function. The user selects a destination through the UI screen, and selects a preferred path when there is a plurality of paths to the destination.

The user sets a message sending function through the UI screen. That is, a menu to set whether to send a message, when a message sending condition is satisfied, as described above, is provided on the UI screen. The user sets the message sending function by selecting the corresponding menu. If the message sending function is set, the user sets a message sending condition, receiver information, and a message text.

The message sending condition is set based on distance information or is set based on an estimated time of arrival or an estimated time required to arrive. A method for setting the message sending condition is explained in detail below.

If the set message sending condition is satisfied, the controller 150 sends the set receiver information and the message to the user terminal apparatus 200 through the communication interface unit 120. Accordingly, the user terminal apparatus 200 sends the message to the server 20 and the server 20 sends the message to the receiver terminal apparatus 30.

Although all of the destination, the message sending condition, the receiver information, and the message sending function are set by the user on the navigation system 100 in the above-embodiment, some information is not input.

That is, according to an embodiment of the present invention, the navigation system 100 directly searches for receiver information without receiving input of the receiver information separately. If a separate communication module is included in the navigation system 100, the controller 150 accesses the web using the network communication module and search for receiver information such as a phone number or an email address corresponding to input destination information. The navigation system 100 sends the message to the receiver through the user terminal apparatus 200 or directly using the searched receiver information.

According to an embodiment of the present invention, the storage unit 110 of the navigation system 100 stores a receiver information database. If the message sending function is set, the controller 150 searches for receiver information corresponding to a destination from the receiver information database. Accordingly, the controller 150 provides the searched receiver information and the message to the user terminal apparatus 200.

According to an embodiment of the present invention, the navigation system 100 searches for receiver information using the user terminal apparatus 200 without receiving input of the receiver information separately. That is, the controller 150 transmits destination information to the user terminal apparatus 200. The user terminal apparatus 200 searches for a phone number or a mail address corresponding to the destination information by executing an application, which is provided to search for receiver information. After that, when the message sending condition is satisfied, the controller 150 sends the message to be forwarded and a command to the user terminal apparatus 200, and the user terminal apparatus 200 sends the message using the receiver information searched by itself.

According to an embodiment of the present invention, the navigation system 100 generates a message by itself. That is, when destination information and a message sending condition are input and the message sending function is set, the controller 150 automatically generates a message to be forwarded by combining the input message sending condition with a pre-stored default message. For example, when an estimated time required to arrive is set to “N” in the message sending condition, the navigation system 100 automatically generates a message, “you will arrive after N minutes,” by combining the message sending condition with a text defined as default. The navigation system 100 automatically generates a message when the user does not input a message text. Alternatively, the message is generated by the user terminal apparatus 200.

According to an embodiment of the present invention, when the communication interface unit 120 is able to communicate with the external server 20, the controller 150 controls the communication interface unit 120 to send the message and the receiver information to the server 20 directly.

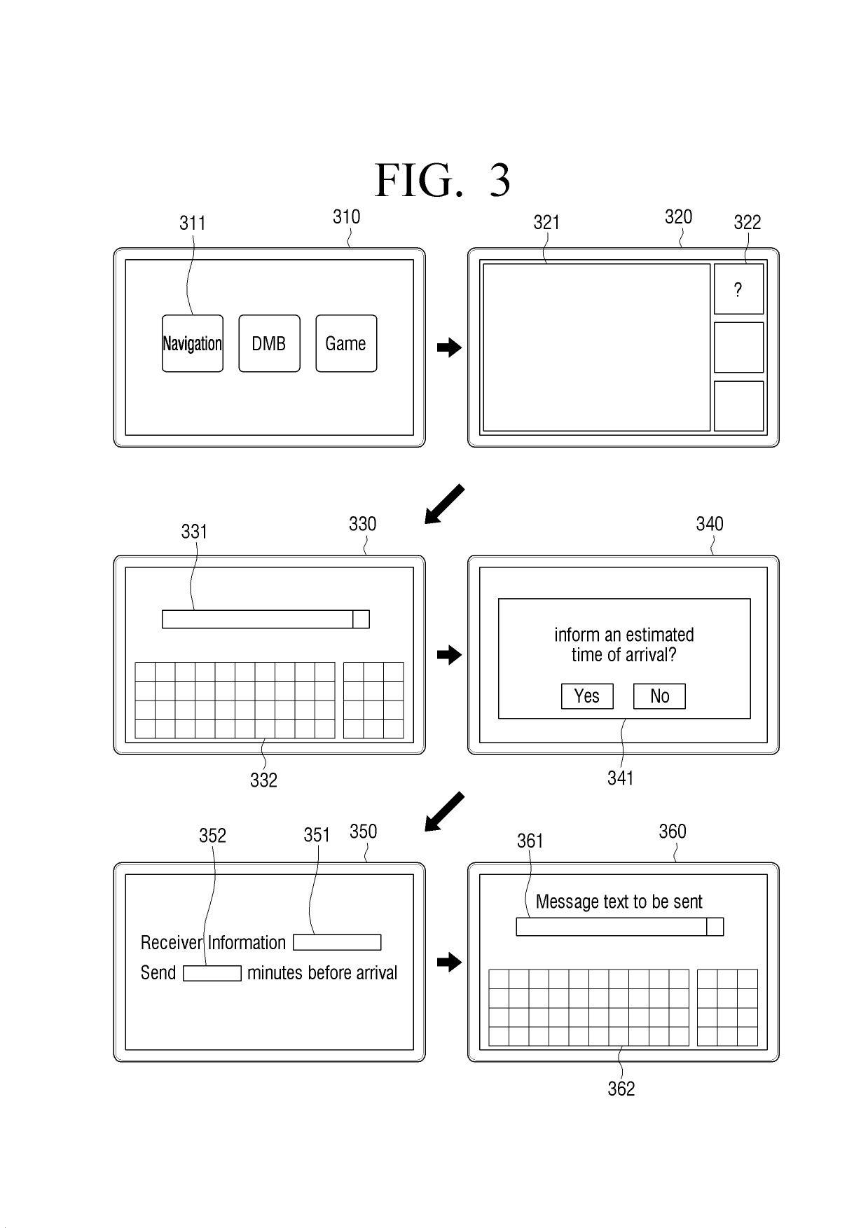

FIG. 3 is a diagram illustrating an example of a method for setting a message sending function in the navigation system 100 according to an embodiment.

Referring to FIG. 3, when the navigation system 100 is turned on, the navigation system 100 displays a background screen 310. A navigation menu 311 is displayed on the background screen 310 along with other menus.

If the user selects the navigation menu 311, a navigation execution screen 320 is displayed. A menu 322 to select destination is displayed on the navigation execution screen 320. If the user selects the menu 322, a screen 330 to input destination is displayed. IN this description, the screen to input a destination is referred to as a first UI screen 330.

The first UI screen 330 includes a soft keyboard 332 to input a text and a display area 331 to display the text input through the soft keyboard 332. The user selects destination by manipulating the soft keyboard 332.

If the destination is selected, a second UI screen 340 including a menu 341 to send a message is displayed. The menu 341 includes a message to ask whether to select a message sending function and buttons to accept or refuse function setting.

If the function setting is selected on the menu 341, a third UI screen 350 including an area 351 to input receiver information and an area 352 to input a message sending condition is displayed.

If receiver information and a message sending condition are input on the third UI screen 350, a fourth UI screen 360 to receive input of a message text to be sent is displayed. The fourth UI screen 360 displays a soft keyboard 362 and a text display area 361 like the first UI screen 330.

As described above, various information such as destination, message sending function setting, receiver information, message sending conditions, and message text are input through at least one UI screen. The configuration and number of the UI screen and the order of inputting the information is changed variously.

In FIG. 3, an estimated time required to arrive is set as the message sending condition. The navigation system 100 determines whether the message sending condition is satisfied or not based on an estimated time required to arrive at destination.

That is, when the message sending condition is set to “N minutes before arriving at destination,” the controller 150 calculates an estimated time required to arrive or an estimated time of arrival in consideration of a moving speed and a location of the vehicle, a remaining distance to the destination, and a traffic condition. The controller 150 compares the calculated time information and the message sending condition, and, when the message sending condition is satisfied, sends the message.

As described above, the message sending condition is set differently according to an embodiment of the present invention.

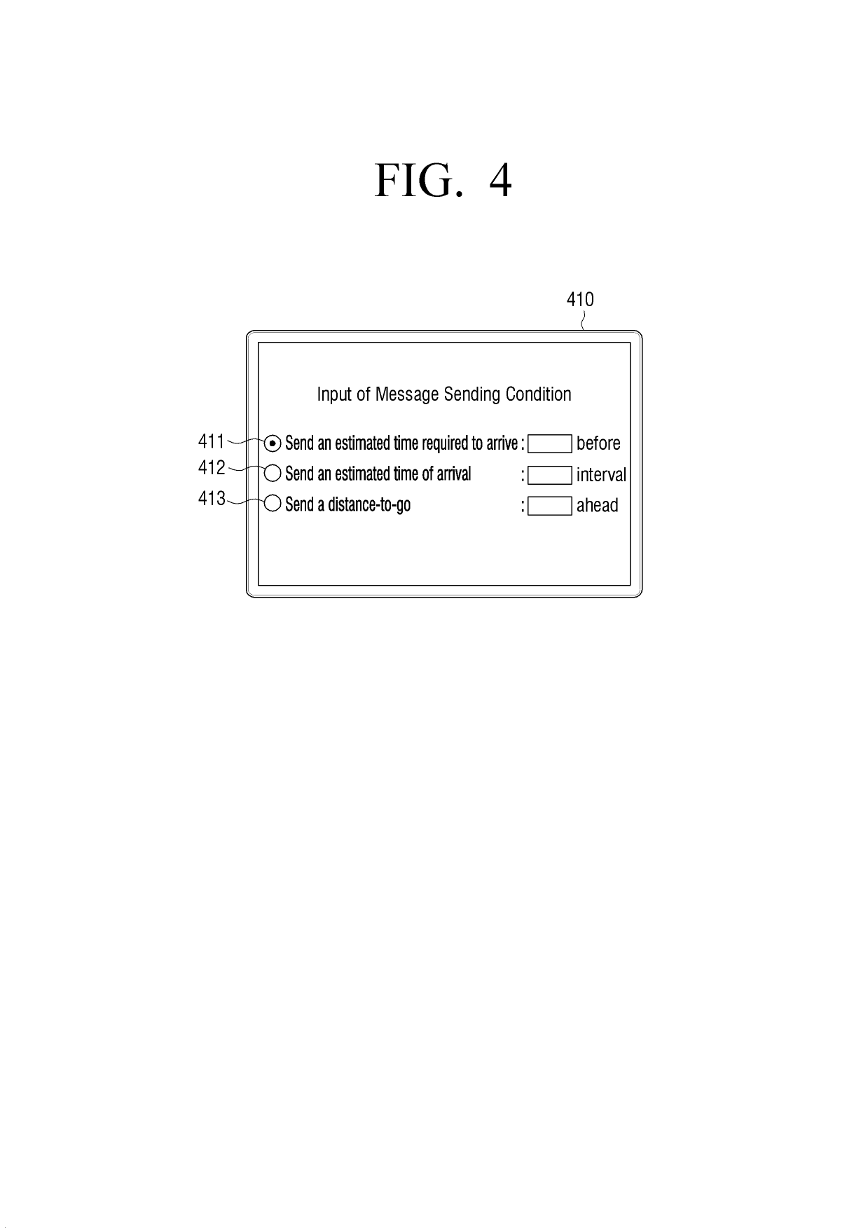

FIG. 4 is a diagram illustrating an example of a UI screen to set various message sending conditions. Referring to FIG. 4, the message sending condition is set to an estimated time required to arrive, an estimated time of arrival, and a remaining distance.

A first menu 411 on a UI screen 410 is to set an estimated time required to arrive, a second menu 412 is to set an estimated time of arrival, and a third menu 413 is to set a remaining distance.

If the user inputs “10 minutes” on the menu 411 to set an estimated time required to arrive, the controller 150 sends a message 10 minutes before arriving at destination. If the user directly inputs a message to be sent, the message is sent as is, and, when the user does not input a message, a message is automatically generated, for example by adding an expression “10 minutes before” to a default message and is sent.

If the menu 412 to send an estimated time of arrival is selected, the user inputs a time interval on a right area of the menu 412. If the user inputs “one hour,” the controller 150 sends a message including an estimated time of arrival every hour from departure until arrival. Alternatively, the user does not input a time interval and the message is sent at a predetermined default time interval.

Alternatively, when the menu 413 to set a remaining distance is selected, the user inputs a remaining distance on a right area of the menu 413. For example, when the user inputs “500 m,” the controller 150 sends a message 500 meters ahead of reaching a destination.

In FIG. 4, the user selects one condition from among the plurality of message sending conditions that are supported.

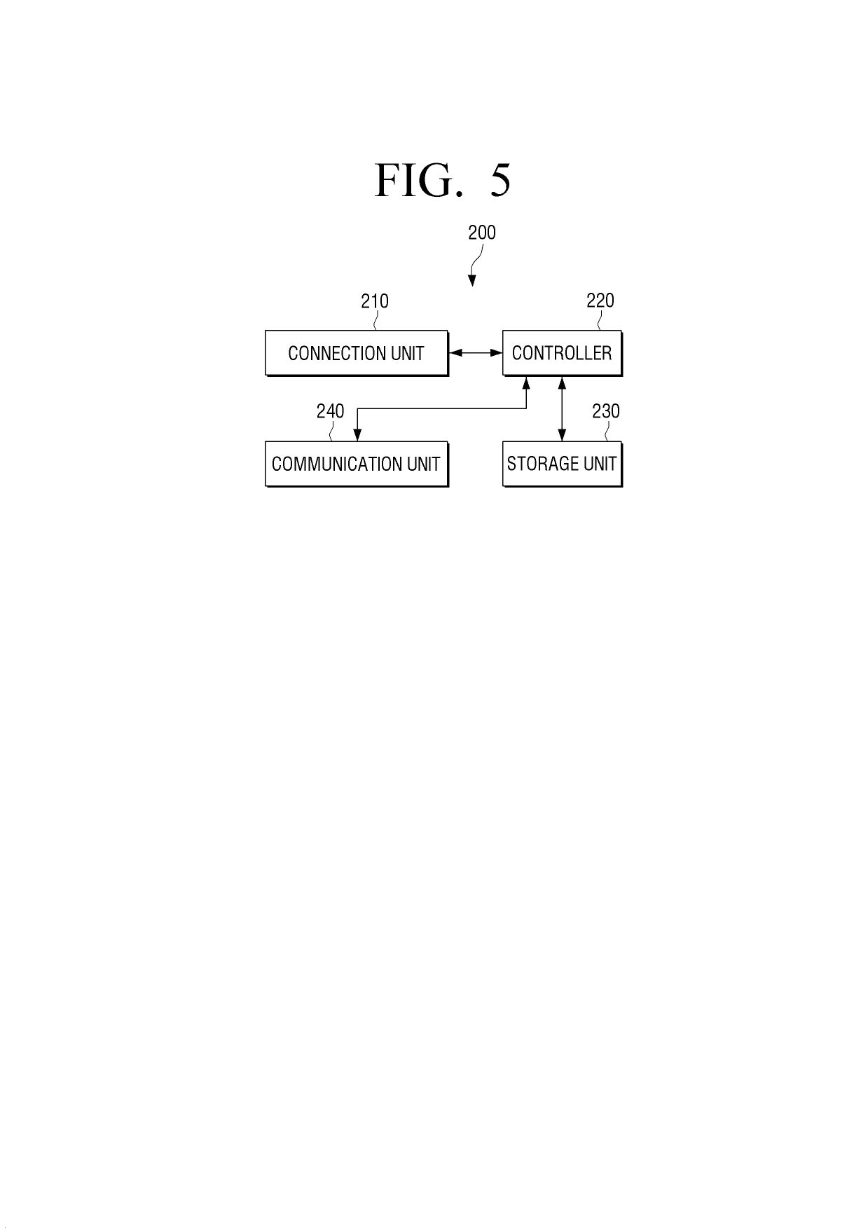

FIG. 5 is a block diagram illustrating a user terminal apparatus 200 which is connected to a navigation system 100 and sends a message. Referring to FIG. 5, the user terminal apparatus 200 includes a connection unit 210, a controller 220, a storage unit 230, and a communication unit 240.

The connection unit 210 is connected to the navigation system 100 through a wired or wireless interface. The storage unit 230 stores various applications, operating systems, and other data. The communication unit 240 communicates with a server 200.

The controller 220 executes an application stored in the storage unit 230 when the user terminal apparatus 200 is connected to the navigation system 100 or receives a message from the navigation system 100. The application includes an application for sending an SMS message or an MMS message or emailing.

The controller 220 sends a message and receiver information which are sent from the navigation system 100 to the server 20 using the executed application. The message and the receiver information is sent in a form of a text message such as an SMS message or an MMS message, or in an email format.

According to another aspect of the present invention, the controller 220 receives destination information from the navigation system 100 and searches for receiver information corresponding to the destination. The search is performed over the web or is performed in a database stored in the storage unit 230. The controller 220 stores the searched receiver information, and, when receiving a message from the navigation system 100, sends the message and the receiver information to the server 200 so that the message can be sent to the receiver information. According to still another aspect of the present invention, the controller 220 directly combines and configure a message text, as described above.

The user terminal apparatus 200 provides a UI or output a voice message to receive user's confirmation on whether to send the message or not prior to sending the message. If the user confirms that the message is sent through touch or voice, the message is directly sent.

The user terminal apparatus 200 of FIG. 5 may be implemented by various apparatuses, such as a mobile phone, a Personal Digital Assistant (PDA), a notebook computer, and a tablet PC. The user terminal apparatus 200 of FIG. 5 is connected to a navigation system mounted in a vehicle, as well as a main unit or a control board mounted in a vehicle to transmit various information regarding the vehicle to the receiver information. For example, a variety of information such as abnormality of a vehicle, a current speed, a location, a current state of remaining oil is transmitted to pre-set receiver information. Additionally, the user terminal apparatus 200 of FIG. 5 is modified to be used in various types of transport systems such as a ship or a motorcycle, besides a vehicle.

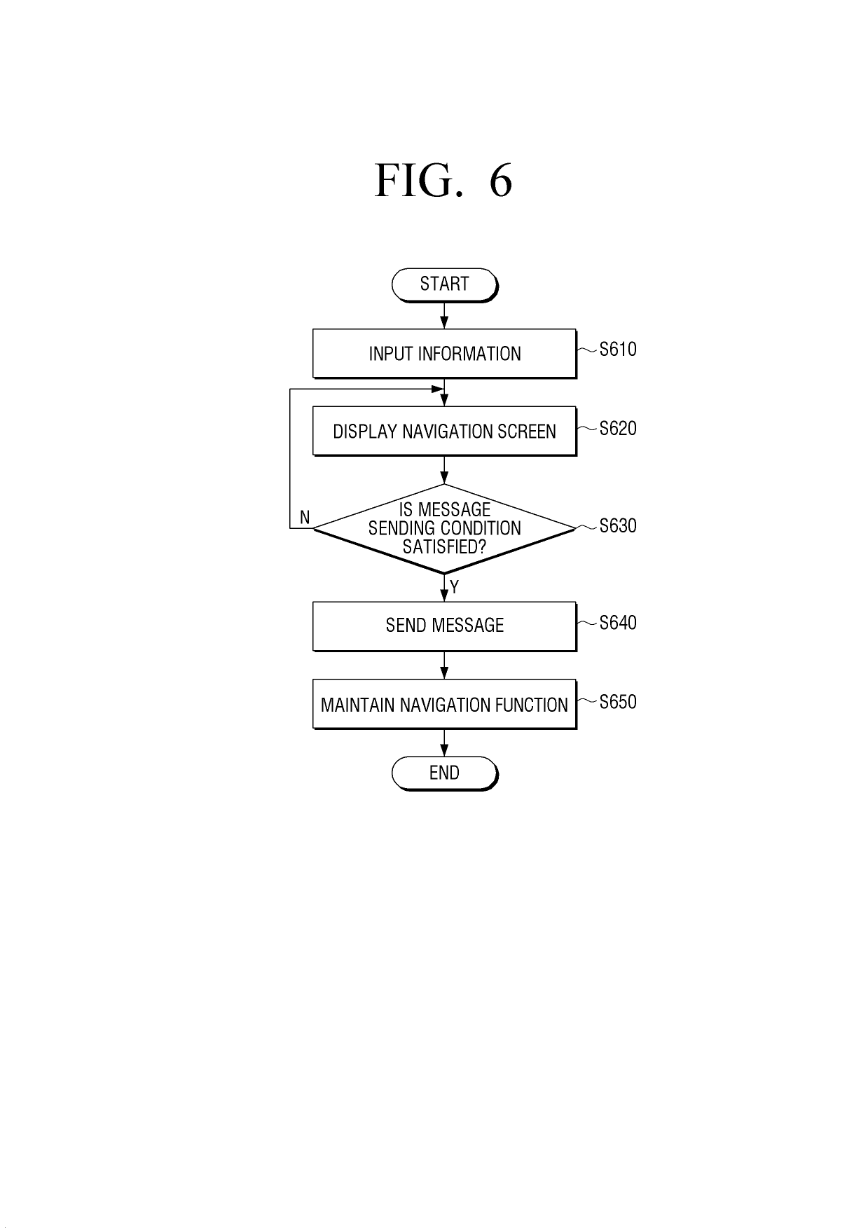

FIG. 6 is a flowchart illustrating a navigation method according to an embodiment of the present invention. Referring to FIG. 6, when a variety of information necessary for navigation is input in Step 610, a navigation screen is displayed by executing a navigation function in Step 620. The input information may be about at least one of destination, whether a message sending function is set or not, a message sending condition, a number of times a message is sent, and a message text to be sent.

If a message sending condition is satisfied while the user runs the vehicle according to the navigation screen in Step 630, a message is sent in Step 640. The message is sent to the receiver through the user terminal apparatus and the server connected to the navigation system, and, when the navigation system includes a communication function, the message is sent to the receiver directly through the server by the navigation system. The message is sent a number of times set by the user or a number of times set as default.

If a distance remains to go to the destination after the message is sent, the navigation function is maintained and the navigation is performed continuously in Step 650.

If the message sending condition is an estimated time required to arrive as described above, the message is sent when a time remaining until arrival is identical to the set time required to arrive.

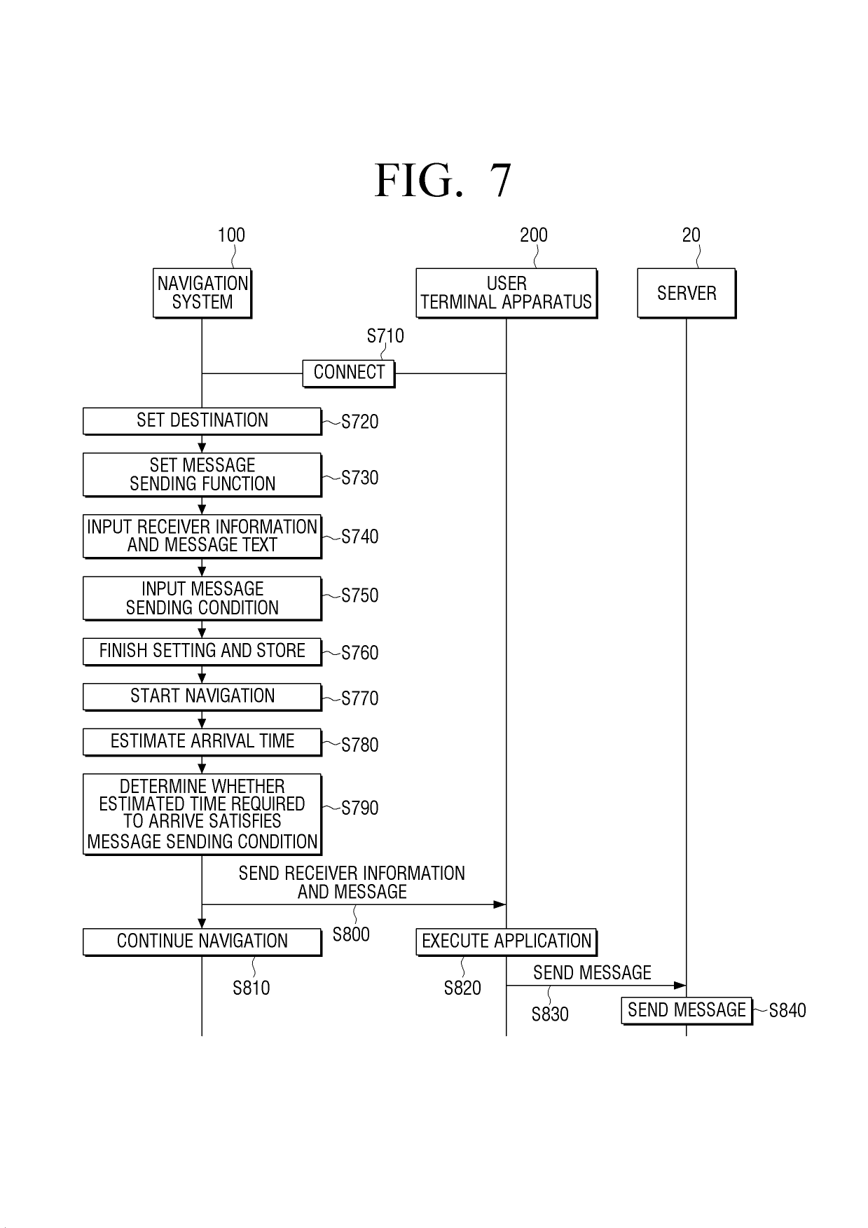

FIG. 7 is a diagram illustrating an interlocking operation among the navigation system 100, the user terminal apparatus 200, and the server 20 when an estimated time required to arrive is set as a message sending condition.

Referring to FIG. 7, the navigation system 100 and the user terminal apparatus 200 are connected to each other in Step 710. The navigation system 100 and the user terminal apparatus 200 are connected to each other through various wired or wireless interfaces such as a USB, Wi-Fi, and Bluetooth®.

When the user executes a navigation function and sets destination in Step 720, a UI screen is displayed. The user sets a message sending function using the UI screen in Step 730, and inputs receiver information, a message text, and a message sending condition in Step 740 and S750. The inputting order or inputting way of the information may be changed variously.

If the input of the information is completed, the set information is stored in Step 760.

The navigation system starts navigation using the set destination information in Step 770. An arrival time is calculated during navigation in Step 780 and it is determined whether an estimated time required to arrive satisfies the message sending condition in Step 790.

If the message sending condition is satisfied, the navigation system 100 sends the receiver information and the message to the user terminal apparatus 200 in Step 800. The user terminal apparatus 200 executes an application for sending a message in Step 820 and sends the receiver information, sender information, and the message text to the sever in Step 830. The server 20 sends a message including the message text to a receiver terminal apparatus using the receiver information in Step 840.

The navigation system 100 continues the navigation when a distance remains to go to the destination after sending the message in Step 810.

As described above, the navigation system 100 is connected to the user terminal apparatus 200 and sends the message to a desired receiver at a time desired by the user. Accordingly, since it is not necessary for the user to manipulate the user terminal apparatus while driving, user's safety is improved.

In the above embodiments, the navigation system 100 includes a touch screen and the user inputs the variety of information and selects the menu in a touch input method. Alternatively, the input of the variety of information and the selection of the menu may be achieved using various buttons on the navigation system 100 or inputting means connected to the navigation system 100.

The navigation system 100 described above is implemented in a main unit for a vehicle or a control system for a vehicle which has a navigation function.

A program to perform the method according to an embodiment of the present invention is stored in various types of recording media. Specifically, a code to perform the above-described methods may be stored in various types of recording media readable by a terminal apparatus, such as a Random Access Memory (RAM), a flash memory, a Read Only Memory (ROM), an Erasable Programmable ROM (EPROM), an Electronically Erasable And Programmable ROM (EEPROM), a register, a hard disk, a removable disk, a memory card, a USB memory, and a CD-ROM.

While the present invention has been shown and described with reference to various embodiments thereof, various changes in form and detail may be made without departing from the scope and spirit of the present invention, defined by the appended claims and their equivalents.

What is claimed is:

1. A navigation method of a navigation system for a vehicle, the navigation method comprising:
when a navigation function is selected, inputting destination and receiver information;
displaying a navigation screen to guide a user to the destination using the input information; and
when a predetermined message sending condition is satisfied while operating the vehicle to the destination, sending a message to be forwarded to the receiver information.

2. The navigation method as claimed in claim 1, wherein sending the message to be forwarded comprises sending the receiver information and the message to a user terminal apparatus which is connected to the navigation system through an interface, and processing the user terminal apparatus to forward the message to the receiver information.

3. The navigation method as claimed in claim 2, wherein inputting the destination and receiver information comprises:
displaying a background screen comprising a navigation menu to execute the navigation function;
when the navigation menu is selected, displaying a UI screen to receive input of the destination information, message sending function setting, the receiver information, a message text, and a message sending condition; and
storing information input through the UI screen.

4. The navigation method as claimed in claim 2, wherein inputting the destination and receiver information comprises:
displaying a background screen comprising a navigation menu to execute the navigation function;
when the navigation menu is selected, displaying a UI screen to receive input of the destination information, message sending function setting, the receiver information, and a message sending condition; and
storing information input through the UI screen,
wherein sending the message to be forwarded further comprises:
when the message sending condition is satisfied, automatically generating a text of a message to be forwarded to the receiver information; and
sending the message of the generated text and the receiver information to the user terminal apparatus.

5. The navigation method as claimed in claim 1, further comprising estimating an arrival time using a moving speed of the vehicle and a path to the destination,
wherein the message sending condition is an estimated time required to arrive at the destination.

6. The navigation method as claimed in claim 1, wherein sending the message comprises directly sending the message to the receiver information.

7. A navigation system for a vehicle, the navigation system comprising:
a storage unit which stores map information;
a location detection unit which detects a location of the navigation system;
a controller which searches for a path to a destination using the map information and the detected location, and generates a navigation screen;
a display unit which displays the navigation screen; and
a communication interface unit through which a message is sent,
wherein, when a message sending condition is satisfied while a user operates the vehicle to the destination, the controller controls the communication interface unit to send a message to be forwarded to pre-input receiver information.

8. The navigation system as claimed in claim 7, wherein the communication interface unit is connected to a user terminal apparatus through an interface,
wherein the controller sends the receiver information and the message to the user terminal apparatus, and processes the user terminal apparatus to forward the message to the receiver information.

9. The navigation system as claimed in claim 8, wherein the controller controls the display unit to display a UI screen to receive input of the destination information, message sending function setting, the receiver information, a message text, and the message sending condition,
wherein the controller stores information input through the UI screen in the storage unit.

10. The navigation system as claimed in claim 8, wherein the controller controls the display unit to display a UI screen to receive input of the destination information, message sending function setting, the receiver information, and the message sending condition, and stores information input through the UI screen in the storage unit,
wherein, when the message sending condition is satisfied, the controller automatically generates a text of a message to be forwarded to the receiver information and controls the communication interface unit to send the message of the generated text and the receiver information to the user terminal apparatus.

11. The navigation system as claimed in claim 7, wherein the controller estimates an arrival time using a moving speed of the vehicle and a path to the destination, and determines whether the message sending condition is satisfied,
wherein the message sending condition is an estimated time required to arrive at the destination.

12. The navigation system as claimed in claim 7, wherein the controller controls the communication interface unit to directly send the message to the receiver information.
